(19) United States
(12) Patent Application Publication
(10) Pub. No.: US 2011/0026175 A1
(43) Pub. Date: Feb. 3, 2011

(54) ELECTROSTATIC DISCHARGE PROTECTING CIRCUIT WITH ULTRA-LOW STANDBY LEAKAGE CURRENT FOR TWICE SUPPLY VOLTAGE TOLERANCE

(75) Inventors: Ming-Dou Ker, Kaohsiung (TW); Chang-Tzu Wang, Kaohsiung (TW); Chua-Chin Wang, Kaohsiung (TW)

Correspondence Address: WPAT, PC;INTELLECTUAL PROPERTY ATTORNEYS, 2030 MAIN STREET, SUITE 1300, IRVINE, CA, 92614, US

(73) Assignee: NATIONAL SUN YAT-SEN UNIVERSITY, Kaohsiung (TW)

(21) Appl. No.: 12/562,426

(22) Filed: Sep. 18, 2009

(30) Foreign Application Priority Data
Jul. 31, 2009 (TW) 098125962

(51) Int. Cl. H02H 9/04

(52) U.S. Cl. 361/56

(57) ABSTRACT

The invention relates to an electrostatic discharge protecting circuit with ultra-low standby leakage current for twice supply voltage tolerance. The electrostatic discharge protecting circuit of the invention includes a substrate driver, a third transistor, a start-up circuit, a RC circuit and a second resistor. The substrate driver has a first transistor and a second transistor in serious connection. The start-up circuit has a fourth transistor and a fifth transistor with diode-connected. The RC circuit has a first resistor, a sixth transistor and a seventh transistor in serious connection. Compared with the prior art, the electrostatic discharge protecting circuit with ultra-low standby leakage current for twice supply voltage tolerance of the invention with advantages of low standby leakage current, high ESD robustness, and no gate-oxide reliability issue is an excellent circuit solution for on-chip ESD protection design for mixed-voltage I/O buffers in nanometer CMOS technologies.

### BACKGROUND OF THE INVENTION

1. Field of the Invention

The present invention relates to an electrostatic discharge protecting circuit, more particularly, an electrostatic discharge protecting circuit with ultra-low standby leakage current for twice supply voltage tolerance.

2. Description of the Related Art

With the decrease of the power supply voltage for low power applications, the thickness of the gate oxide has been also scaled down in the nanometer CMOS technologies. The circuit designs quickly migrate to lower VDD voltage level such as 1V in a 65-nm CMOS process to reduce the power consumption. However, some peripheral components or other ICs in a microelectronic system are still operated at the higher voltage levels. With consideration on the whole system integration, the I/O buffers may drive or receive high-voltage signals to communicate with other ICs. Several problems arise in the I/O interface between these ICs, such as the gate-oxide breakdown (referring to prior art references [1]-[3]) and the undesirable leakage current paths (referring to prior art references [4]).

In addition to the problems in the I/O interface, a more important issue occurs when devices implementing in nanoscale CMOS technologies. Such a thin gate oxide of only ˜2 nm in a 0.13 μm CMOS technology has been reported to result in a substantial fraction of the overall leakage current in the chip due to its gate leakage current (referring to prior art references [5]). In 45-nm generation and beyond, the high-k metal gate technology is therefore applied to reduce the gate leakage current (referring to prior art references [6], [7]). Nevertheless, the gate leakage issue still exists in the 90-nm and 65-nm CMOS technologies which are currently used in production without metal gate structure. The gate current has been modeled in BSIM4 MOSFET model (referring to prior art references [8]), and the foundries have also provided the corresponding SPICE models of nanometer CMOS processes to circuit designers. Recently, some work has been reported on how to reduce the gate leakage current for digital circuits in advanced CMOS processes (referring to prior art references [9], [10]).

For commercial IC products, to achieve the electrostatic discharge (ESD) specification is necessary for product qualification. The on-chip ESD protection circuit for mixed-voltage I/O interfaces should meet the gate-oxide reliability constraints and prevent the undesired leakage current paths during normal circuit operating condition. Some literatures have been reported to solve the ESD protection design for the mixed-voltage I/O interfaces, by using the additional thick gate-oxide process, the stacked-MOS configuration, or the high-voltage-tolerant ESD clamp circuit to solve the problems of the gate-oxide reliability (referring to prior art references [11]-[13]). Recently, an ESD protection design with on-chip ESD Bus and high-voltage-tolerant ESD clamp circuit with only thin gate-oxide devices has been successfully verified in 0.13-μm CMOS process (referring to prior art references [14]). However, the prior designs did not consider the effect of gate leakage current if such circuits are further implemented in nanometer CMOS processes.

The simulated total gate current of the MOS capacitor with W/L of 5 μm/5 μm and 10 μm/10 μm in 65-nm and 90-nm CMOS processes are shown in FIG. 1. From FIG. 1, the gate current of a MOS capacitor is directly dependent on the area of the poly gate structure. Besides, the gate leakage problem in 65-nm CMOS process is more serious than that in 90-nm CMOS process.

FIG. 2 shows the conventional 2×VDD-tolerant ESD clamp circuit used to protect the mixed-voltage I/O buffers (referring to prior art references [14]). Based on BSIM4 model, the STNMOS 24 in FIG. 2 with large device size as the conventional ESD detection circuit 21 generates some leakage current from VDD_H to VDD via the gate of the first transistor 22. Furthermore, the sub-threshold leakage current of the STNMOS 24 in a nanoscale CMOS technology is also large. In the conventional ESD detection circuit 21, the MOS capacitor with gate oxide of large area will induce a large amount of gate current from node A1 to VDD under the normal circuit operating condition. Therefore, the leakage current path exists from VDD_H through the first resistor 211, the third transistor 212, and the second resistor 213 to VDD. Such gate current causes a voltage drop across the first resistor 211, and therefore the fourth transistor 214 (PMOS) in the conventional ESD detection circuit 21 can not be completely turned off. With a non-turned-off the fourth transistor 214 (PMOS), node D1 could be charged up to some voltage level higher than VSS, and that in turn provides some triggered current into the substrate of STNMOS 24 under the normal circuit operating condition. The STNMOS 24 with weak triggered current could further induce extra leakage current. Both the ESD detection circuit 21 and STNMOS 24 in this prior work suffer serious leakage current issue when the conventional ESD clamp circuit 20 is implemented in a nanoscale CMOS technology.

By simulation with 65-nm SPICE parameters provided by foundry, the leakage current of STNMOS 24 with W/L of 320 μm/0.12 μm under the bias conditions of VDD_H of 1.8V and VDD of 1V is higher than 1 μA. The standby leakage current of the prior work of whole conventional ESD clamp circuit 20 will cause a considerable leakage current of several micro-Amperes under the normal circuit operating condition with VDD_H of 1.8V and VDD of 1V in a 65-nm CMOS process. Such a leaky ESD protection circuit 21 is barely tolerable for low power requirements.

Therefore, there is need for providing an electrostatic discharge protecting circuit with ultra-low standby leakage current for twice supply voltage tolerance to solve the above problems.

### SUMMARY OF THE INVENTION

The present invention is directed to an electrostatic discharge protecting circuit with ultra-low standby leakage current for twice supply voltage tolerance. The electrostatic discharge protecting circuit of the invention includes a substrate driver, a third transistor, a start-up circuit, a RC circuit and a second resistor. The substrate driver has a first transistor and a second transistor in serious connection, and is connected between a twice supply voltage and a trigger node. The third transistor is connected to the trigger node. The start-up circuit has a fourth transistor and a fifth transistor with diode-connected, and is connected to the second transistor and the third transistor. The RC circuit has a first resistor, a sixth transistor and a seventh transistor in serious connection, and is connected to the twice supply voltage and the third transistor. The second resistor is connected to a supply voltage and the RC circuit.

The electrostatic discharge protecting circuit with ultra-low standby leakage current for twice supply voltage tolerance of the invention realized with only low-voltage (the supply voltage, 1×VDD) devices can effectively protect the mixed-voltage I/O buffers without gate-oxide reliability issue under the normal circuit operating conditions. Compared with the prior art, the electrostatic discharge protecting circuit of the invention with advantages of low standby leakage current, high ESD robustness, and no gate-oxide reliability issue is an excellent circuit solution for on-chip ESD protection design for mixed-voltage I/O buffers in nanometer CMOS technologies.

### BRIEF DESCRIPTION OF THE DRAWINGS

FIG. 1 shows simulated total gate current of the MOS capacitor with W/L of 5 μm/5 μm and 10 μm/10 μm in 65-nm and 90-nm CMOS processes;

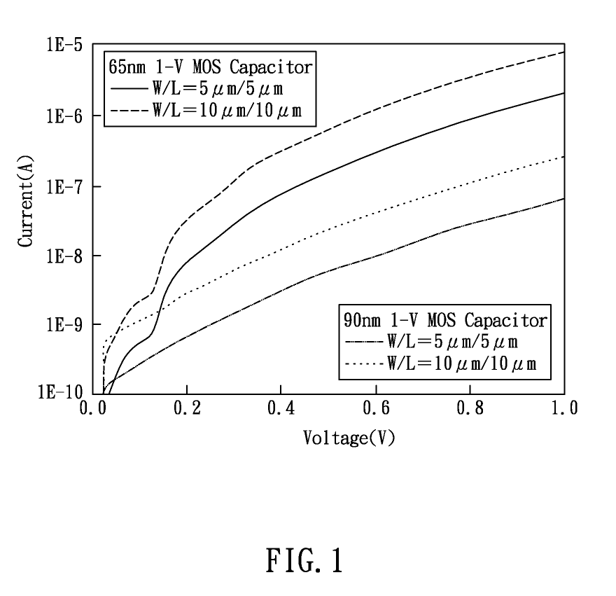

FIG. 2 shows the conventional 2×VDD-tolerant ESD clamp circuit used to protect the mixed-voltage I/O buffers;

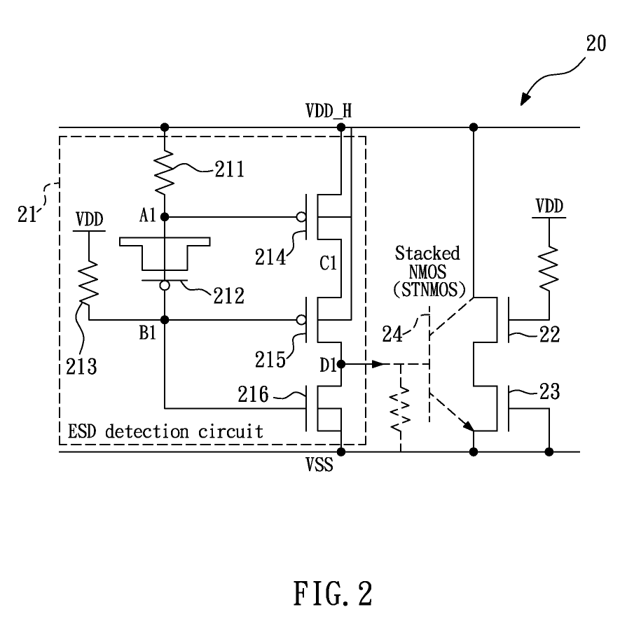

FIG. 3 is an electrostatic discharge protecting circuit with ultra-low standby leakage current for twice supply voltage tolerance according to the present invention;

FIG. 4 shows the simulated voltage waveforms at the nodes of the ESD detection circuit during and after the normal power-on transition; and

FIG. 5 shows the simulated voltage and substrate-triggered current of the ESD detection circuit during the ESD transition.

### DETAILED DESCRIPTION OF THE INVENTION

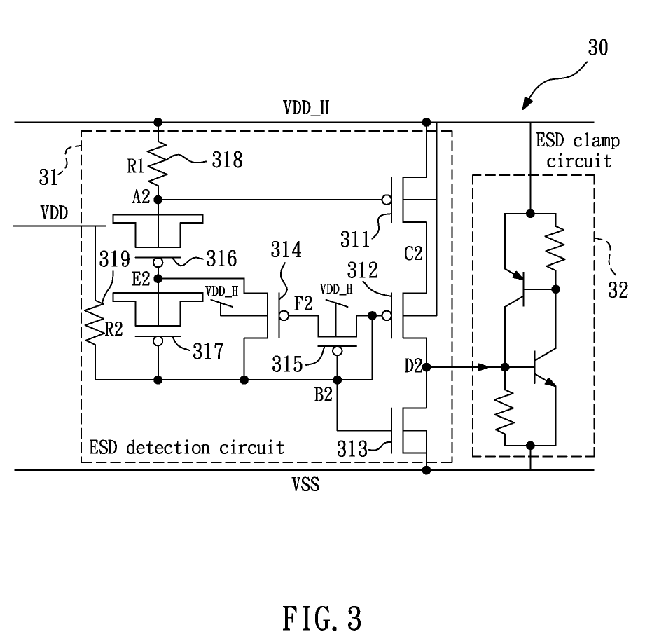

FIG. 3 is an electrostatic discharge protecting circuit with ultra-low standby leakage current for twice supply voltage tolerance according to the present invention. The electrostatic discharge protecting circuit 30 of the invention includes a substrate driver, a third transistor 313, a start-up circuit, a RC circuit and a second resistor 319. The substrate driver has a first transistor 311 and a second transistor 312 in serious connection, and is connected between a twice supply voltage (VDD_H) and a trigger node D2.

The third transistor 313 is connected to the trigger node D2. The start-up circuit has a fourth transistor 314 and a fifth transistor 315 with diode-connected, and is connected to the second transistor 312 and the third transistor 313. The RC circuit has a first resistor 318, a sixth transistor 316 and a seventh transistor 317 in serious connection, and is connected to the twice supply voltage (VDD_H) and the third transistor 313. The second resistor 319 is connected to a supply voltage (VDD) and the RC circuit.

In the embodiment, the first transistor 311 and the second transistor 312 are PMOS transistors, the third transistor 313 is a NMOS transistor, and the fourth transistor 314 and the fifth transistor 315 are PMOS transistors.

The electrostatic discharge protecting circuit 30 of the invention further includes a first connecting node A2 for connecting the first resistor 318 and a gate of the first transistor 311. The electrostatic discharge protecting circuit 30 of the invention further includes a second connecting node B2 for connecting the second resistor 319, a gate of the second transistor 312, a gate of the third transistor 313, a gate of the fifth transistor 315 and a gate of the seventh transistor 317.

The electrostatic discharge protecting circuit 30 of the invention further includes a third connecting node E2 for connecting a gate of the sixth transistor 316, a bulk of the seventh transistor 317 and the fourth transistor 314. The electrostatic discharge protecting circuit 30 of the invention further includes a fourth connecting node F2 for connecting the fourth transistor 314 and the fifth transistor 315.

The substrate driver, the third transistor 313, the start-up circuit, the RC circuit and the second resistor 319 can be an electrostatic discharge (ESD) detection circuit 31.

The electrostatic discharge protecting circuit 30 of the invention further includes an electrostatic discharge clamp circuit 32 connected to the trigger node D2, and the electrostatic discharge clamp circuit 32 is a p-type substrate-triggered silicon-controlled rectifier, and has cross-coupled n-p-n transistor and p-n-p transistor (referring to prior art references [15]). The electrostatic discharge clamp circuit 32 with a low holding voltage can sustain a high ESD level within a small silicon area in CMOS process. Moreover, the electrostatic discharge clamp circuit 32 without poly gate structure has good immunity against the gate leakage problem.

In the embodiment, the electrostatic discharge protecting circuit 30 is realized with only 1-V thin oxide devices to operate under 1.8-V (VDD_H) without suffering the gate-oxide reliability issue. Furthermore, the ESD detection circuit 31 is used to improve the turn-on speed of the electrostatic discharge clamp circuit 32 with substrate-triggered mechanism. The ESD detection circuit 31 with only 1-V thin oxide devices is designed with consideration of the gate current and gate-oxide reliability in this embodiment. By utilizing the gate current to bias the ESD detection circuit 31 and optimizing the voltage difference across the gates of the MOS capacitors, the gate leakage current through the MOS capacitor under the normal circuit operating condition can be reduced. The total leakage current resulted from the MOS capacitor in the ESD detection circuit 31 can be minimized. Therefore, the leakage currents through the electrostatic discharge clamp circuit 32 and the ESD detection circuit 31 can be well controlled and minimized by the invention.

In the embodiment, the first transistor 311 and the second transistor 312 are used to generate the substrate-triggered current into the trigger node D2 during ESD stress event, but the substrate driver is kept off under the normal circuit operating condition. The third transistor 313 is used to keep the trigger node D2 at VSS, so the electrostatic discharge clamp circuit 32 is guaranteed to be turned off during the normal circuit operating condition.

The RC time constant from the first resistor 318, the sixth transistor 316, the seventh transistor 317, and the parasitic gate capacitance of the third transistor 313 is designed around the order of ˜μs to distinguish ESD stress event from the normal power-on condition.

The diode-connected fourth transistor 314 and the fifth transistor 315 are acted as a start-up circuit with initial gate-to-bulk current from the twice supply voltage (VDD_H) into the ESD detection circuit 31, and in turn to conduct some gate current of the sixth transistor 316 to bias the third connecting node E2 and the fourth connecting node F2. After that, the voltage level at the third connecting node E2 will be biased at a specified voltage level to reduce the voltage difference across the gate of the sixth transistor 316 and to minimize the gate leakage current through the MOS capacitors.

### A. Operation Under Normal Circuit Operating Condition

During the normal circuit operating condition with VDD_H of 1.8V, VDD of 1V, and grounded VSS, the gate voltage (the first connecting node A2) of the first transistor 311 is biased at around 1.8V through the first resistor 318 with a low gate current of the sixth transistor 316 (MOS capacitor) in the ESD detection circuit 31, so that the first transistor 311 can be kept off and no trigger current is generated from the ESD detection circuit 31 to the electrostatic discharge clamp circuit 32. In addition, the second connecting node B2 is biased at 1V through the second resistor 319 (1-kΩ) to turn on the third transistor 313 which in turn keeps the trigger node D2 of the electrostatic discharge clamp circuit 32 grounded. Due to the off-state of the first transistor 311, no current flows from VDD_H though the first transistor 311 and the second transistor 312 to VSS, so the second transistor 312 is also kept in off state.

The source-to-gate voltage of the second transistor 312 is less than the threshold voltage of a 1-V PMOS transistor, and therefore the fifth connecting node C2 is kept between 1V and (1V+|Vtp|). The third connecting node E2 is biased at ˜1.4V and the fourth connecting node F2 is biased at some voltage level between that at the second connecting node B2 (1V) and the third connecting node E2 (˜1.4V). Under such a bias condition, all 1-V devices in the ESD detection circuit 31 are free from gate-oxide reliability issue under normal circuit operating condition.

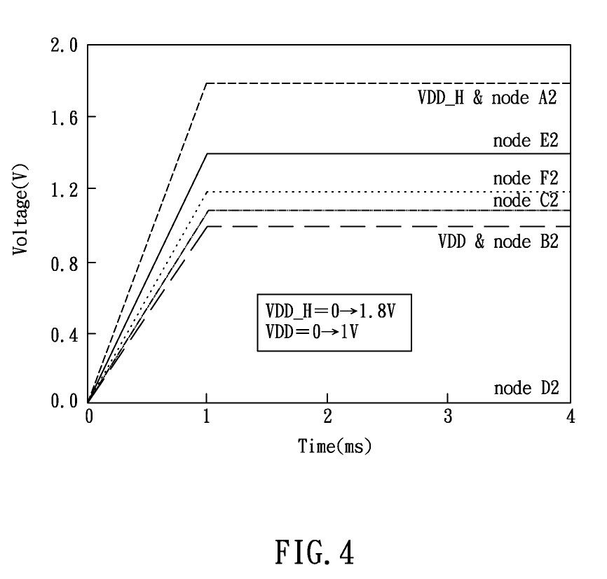

FIG. 4 shows the simulated voltage waveforms at the nodes of the ESD detection circuit during and after the normal power-on transition. VDD_H and VDD are powered on to 1.8V and 1V, respectively, with a simultaneous rise time of 1 ms. From the simulation results, the voltage differences across the gate-to-drain, gate-to-source, and gate-to-bulk terminals of all devices in the ESD detection circuit 31 do not exceed the process limitation (1.1V for 1-V devices in a 65-nm CMOS process). Therefore, the ESD detection circuit 31 can be ensured against gate-oxide reliability issue under the normal circuit operating condition.

### B. Operation Under ESD Transient Event

When a positive fast-transient ESD voltage is applied to VDD_H with VSS relatively grounded and VDD floating, the RC delay in the ESD detection circuit 31 keeps the gate (the first connecting node A2) of the first transistor 311 at a relatively low voltage level compared to the fast rising voltage level at VDD_H. The second connecting node B2 is initially floating via VDD with a voltage level of around 0V and charged up slowly due to the RC delay, too. The first transistor 311 and the second transistor 312, whose initial gate voltages are at relatively low voltage levels compared to their source voltages, can be quickly turned on by the ESD energy to generate the substrate-triggered current into the trigger node D2. Finally, the electrostatic discharge clamp circuit 32 can be fully turned on into holding state to discharge the ESD current from VDD_H to VSS.

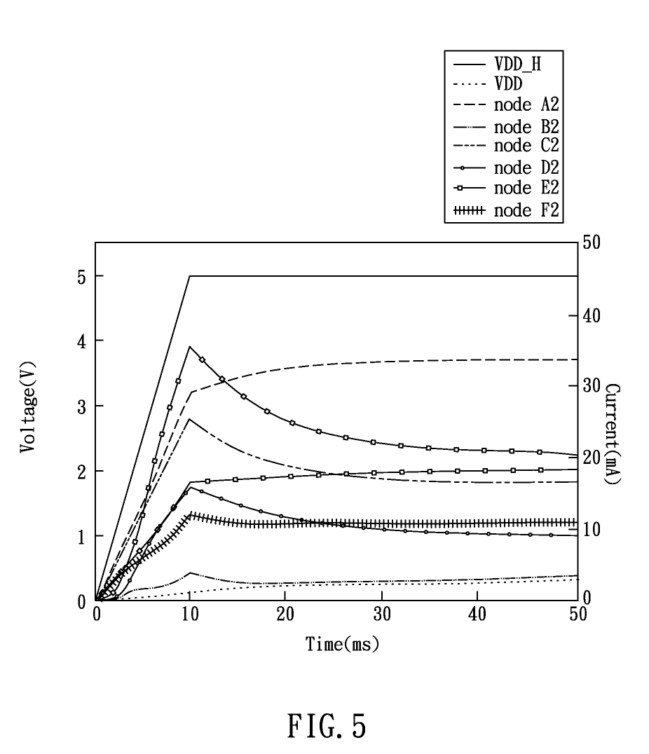

FIG. 5 shows the simulated voltage and substrate-triggered current of the ESD detection circuit during the ESD transition. A 0-to-5V voltage pulse with a rise time of 10 ns is applied to VDD_H to simulate the fast transient voltage of human-body-model (HBM) ESD event (referring to prior art references [16]). With a limited voltage height of 5V in the voltage pulse, the voltage transition on each node in the ESD detection circuit can be simulated to check the desired circuit function before device breakdown. From the simulated results, the source-to-gate voltages of the first transistor 311 and the second transistor 312 are around 1.5V, which is much higher than their threshold voltage, and the substrate-triggered peak current generated from substrate driver is higher than 30 mA during the ESD transition. With the ESD detection circuit 31, the electrostatic discharge clamp circuit 32 can be triggered on by the adequate substrate-triggered current before device breakdown during the ESD stress event.

The electrostatic discharge protecting circuit with ultra-low standby leakage current for twice supply voltage tolerance of the invention has been successfully verified in a 65-nm CMOS process. All devices used in electrostatic discharge protecting circuit are 1-V fully-silicided devices. The electrostatic discharge protecting circuit realized with only low-voltage (1×VDD) devices can effectively protect the mixed-voltage I/O buffers without gate-oxide reliability issue under the normal circuit operating conditions. The ESD detection circuit 31, designed with consideration of gate leakage current, has been verified with a very small standby leakage current of only 0.15 μA under 1.8-V bias at 25° C., and has also shown the effectiveness on reducing the trigger voltage of the electrostatic discharge clamp circuit 32. Compared with the prior art references, the electrostatic discharge protecting circuit of the invention with advantages of low standby leakage current, high ESD robustness, and no gate-oxide reliability issue is an excellent circuit solution for on-chip ESD protection design for mixed-voltage I/O buffers in nanometer CMOS technologies.

While the embodiments of the present invention have been illustrated and described, various modifications and improvements can be made by those skilled in the art. The embodiments of the present invention are therefore described in an illustrative but not restrictive sense. It is intended that the present invention may not be limited to the particular forms as illustrated, and that all modifications that maintain the spirit and scope of the present invention are within the scope as defined in the appended claims.

### PRIOR ART REFERENCES

[1]. T. Furukawa, D. Turner, S. Mittl, M. Maloney, R. Serafin, W. Clark, L. Longenbach, and J. Howard, “Accelerated gate-oxide breakdown in mixed-voltage I/O circuits,” in Proc. IEEE Int. Reliability Physics Symp., 1997, pp. 169-173.
[2]. B. Kaczer, R. Degraeve, M. Rasras, K. Van de Mieroop, P. J. Roussel, and G. Groeseneken, “Impact of MOSFET gate oxide breakdown on digital circuit operation and reliability,” IEEE Trans. Electron Devices, vol. 49, no. 3, pp. 500-506, March 2002.
[3]. Y. Luo, D. Nayak, D. Gitlin, M.-Y. Hao, C.-H. Kao, and C.-H. Wang, “Oxide reliability of drain engineered I/O NMOS from hot carrier injection,” IEEE Electron Device Lett., vol. 24, no. 11, pp. 686-688, November 2003.
[4]. S. Dabral and T. Maloney, Basic ESD and I/O Design, John Wiley & Sons, 1998.
[5]. L. K. Han, S. Biesemans, J. Heidenreich, K. Houlihan, C. Lin, V. McCahay, T. Schiml, A. Schmidt, U. P. Schroeder, M. Stetter, C. Warm, D. Warner, R. Mahnkopf, and B. Chen, “A modular 0.13 m bulk CMOS technology for high performance and low power applications”, in Proc. Symp. VLSI Technol. Dig. Tech. Papers, 2000, pp. 12-13.
[6]. Z. Krivokapic, W. Maszara, K. Achutan, P. King, J. Gray, M. Sidorow, E. Zhao, J. Zhang, J. Chan, A. Marathe, and M.-R. Lin, “Nickel silicide metal gate FDSOI devices with improved gate oxide leakage,” in IEDM Tech. Dig., 2002, pp. 271-274.
[7]. C.-H. Jan, P. Bai, S. Biswas, M. Buehler, Z.-P. Chen, G. Curello, S. Gannavaram, W. Hafez, J. He, J. Hicks, U. Jalan, N. Lazo, J. Lin, N. Lindert, C. Litteken, M. Jones, M. Kang, K. Komeyli, A. Mezhiba, S. Naskar, S. Olson, J. Park, R. Parker, L. Pei, I. Post, N. Pradhan, C. Prasad, M. Prince, J. Rizk, G. Sacks, H. Tashiro, D. Towner, C. Tsai, Y. Wang, L. Yang, J.-Y. Yeh, J. Yip, and K. Mistry, “A 45 nm low power system-on-chip technology with dual gate (logic and I/O) high-k/metal gate strained silicon transistors,” in IEDM Tech. Dig., 2008, pp. 637-640.
[8]. BSIM Model, Berkeley Short-Channel IGFET Model. [Online]. Available: http://www-device.eecs.berkeley.edu/˜bsim3/bsim4.html
[9]. K. Sathyaki and P. Paily, “Leakage reduction by modified stacking and optimum ISO input loading in CMOS devices,” in Proc. IEEE Int. Conf on Advanced Computing and Communications, 2007, pp. 220-225.
[10]. M. Agarwal, P. Elakkumanan, and R. Sridhar, “Leakage reduction for domino circuits in sub-65-nm technologies,” in Proc. IEEE Int. SOC Conf, 2006, pp. 164-167.
[11]. M.-D. Ker and K.-H. Lin, “Overview on electrostatic discharge protection designs for mixed-voltage I/O interfaces: design concept and circuit implementations,” IEEE Trans. Circuits Syst. I: Regular Papers, vol. 53, no. 2, pp. 235-246, February 2006.
[12]. M.-D. Ker and C.-T. Wang, “ESD protection design by using only 1×VDD low-voltage devices for mixed-voltage I/O buffers with 3×VDD input tolerance,” in Proc. IEEE Asian Solid-State Circuits Conf, 2006, pp. 287-290.
[13]. M.-D. Ker, C.-T. Wang, T.-H. Tang, and K.-C. Su, “Design of high-voltage-tolerant power-rail ESD clamp circuit in low-voltage CMOS processes,” in Proc. of IEEE Int. Reliability Physics Symp., 2007, pp. 594-595.
[14]. M.-D. Ker and W.-J. Chang, “ESD protection design with on-chip ESD bus and high-voltage-tolerant ESD clamp circuit for mixed-voltage IO buffers,” IEEE Trans. Electron Devices, vol. 55, no. 6, pp. 1409-1416, June 2008.
[15]. M.-D. Ker and K.-C. Hsu, “Latchup-free ESD protection design with complementary substrate-triggered SCR devices,” IEEE J. Solid-State Circuits, vol. 38, no. 8, pp. 1380-1392, August 2003.
[16]. ESD Association Standard Test Method ESD STM5.1-2001, for Electrostatic Discharge Sensitivity Testing—Human Body Model (HBM)—Component Level, 2001.

What is claimed is:

1. An electrostatic discharge protecting circuit with ultra-low standby leakage current for twice supply voltage tolerance, comprising:
a substrate driver, having a first transistor and a second transistor in serious connection, and connected between a twice supply voltage and a trigger node;
a third transistor, connected to the trigger node;
a start-up circuit, having a fourth transistor and a fifth transistor with diode-connected, and connected to the second transistor and the third transistor;
a RC circuit, having a first resistor, a sixth transistor and a seventh transistor in serious connection, and connected to the twice supply voltage and the third transistor; and
a second resistor, connected to a supply voltage and the RC circuit.

2. The electrostatic discharge protecting circuit according to claim 1, further comprising an electrostatic discharge clamp circuit, connected to the trigger node, wherein the electrostatic discharge clamp circuit is a p-type substrate-triggered silicon-controlled rectifier, and has cross-coupled n-p-n transistor and p-n-p transistor.

3. The electrostatic discharge protecting circuit according to claim 1, wherein the first transistor and the second transistor are PMOS transistors, the third transistor is a NMOS transistor, and the fourth transistor and the fifth transistor are PMOS transistors.

4. The electrostatic discharge protecting circuit according to claim 1, further comprising a first connecting node for connecting the first resistor and a gate of the first transistor.

5. The electrostatic discharge protecting circuit according to claim 1, further comprising a second connecting node for connecting the second resistor, a gate of the second transistor, a gate of the third transistor, a gate of the fifth transistor and a gate of the seventh transistor.

6. The electrostatic discharge protecting circuit according to claim 1, further comprising a third connecting node for connecting a gate of the sixth transistor, a bulk of the seventh transistor and the fourth transistor.

7. The electrostatic discharge protecting circuit according to claim 1, further comprising a fourth connecting node for connecting the fourth transistor and the fifth transistor.
